(19) United States
(12) Patent Application Publication
(10) Pub. No.: US 2016/0039189 A1
(43) Pub. Date: Feb. 11, 2016

(54) COMPOSITE FILM AND METHOD FOR FABRICATING SAME

(71) Applicant: Peixiang Xing, Sioux Falls, SD (US)

(72) Inventor: Peixiang Xing, Sioux Falls, SD (US)

(21) Appl. No.: 14/823,853

(22) Filed: Aug. 11, 2015

Related U.S. Application Data
(60) Provisional application No. 62/035,836, filed on Aug. 11, 2014.
(60) Provisional application No. 62/086,255, filed on Dec. 2, 2014.

(51) Int. Cl. B32B 27/12; B32B 27/20; B32B 7/06; B32B 5/02

(52) U.S. Cl. CPC B32B 27/12; B32B 5/022; B32B 27/20; B32B 7/06; B32B 2262/0276; B32B 2262/12; B32B 2264/102; B32B 2405/00; B32B 2305/20; B32B 2605/00; B32B 2264/02; B32B 2264/12; B32B 2307/4026

(57) ABSTRACT

A composite film comprises a polymer layer comprising polybutylene terephthalate loaded with from about 0.5 wt. % to about 15 wt. % of a pigment, and from about 0.5 wt. % to about 1.5 wt. % of a UV stabilizer, and a fabric substrate layer at least partially embedded in and bonded to the polymer layer.

### CLAIM OF PRIORITY

This patent application claims the benefit of priority to U.S. Provisional Application No. 62/035,836, filed Aug. 11, 2014 and to U.S. Provisional Application No. 62/086,255, filed Dec. 2, 2014, which are hereby incorporated by reference herein in their entirety.

### BACKGROUND

Polybutylene terephthalate (PBT) is a polymer with good mechanical strength, heat resistance, chemical resistance, and electrical properties, and can be used as a gas barrier. Therefore, PBT has been used for many applications where durability is desired, such as automobile parts or electronics parts.

### SUMMARY

The present disclosure describes a composite film comprising PBT bonded to a fabric substrate, such as a non-woven fabric substrate. The present disclosure also describes a composite panel made by extruding a relatively thick plastic layer, such as a polyolefin layer, for example a polyethylene layer or a polypropylene layer, on the fabric side of the composite film. The present disclosure also describes a composite panel made by laminating a fabric side of a composite film with a laminating adhesive onto a preformed substrate or board, such as a polyolefin substrate or board, for example a polyethylene board or a polypropylene board. The present disclosure also describes methods of fabricating the composite films and the composite panels described herein.

In an example, the present disclosure describes a composite film comprising a polymer layer comprising polybutylene terephthalate loaded with from about 2 wt. % to about 15 wt. % of a titanium dioxide pigment, and from about 0.5 wt. % to about 1.5 wt. % of a UV stabilizer, and a fabric substrate layer at least partially embedded in and bonded to the polymer layer. The polymer layer can also include from about 0.1 wt. % to about 0.3 wt. % of an antioxidant.

In another example, the present disclosure describes a composite film comprising a polymer layer comprising polybutylene terephthalate loaded with from about 0.5 wt. % to about 15 wt. % of a pigment, and from about 0.5 wt. % to about 1.5 wt. % of a UV stabilizer, a fabric substrate layer at least partially embedded in and bonded to the polymer layer, and an additional layer bonded to the fabric substrate layer, the additional layer comprising at least one of: a rigid or substantially rigid substrate; an adhesive; a sealant; and a lamination adhesion layer. The polymer layer of the composite film can also comprise from about 0.1 wt. % to about 0.3 wt. % of an antioxidant.

### BRIEF DESCRIPTION OF THE FIGURES

FIG. 1 is a cross-sectional side view of an example composite film.

FIG. 2 is a cross-sectional side view of another example composite film.

FIG. 3 is a cross-sectional side view of an example composite panel.

FIG. 4 is a cross-sectional side view of another example composite panel.

### DETAILED DESCRIPTION

In the following Detailed Description, reference is made to the accompanying drawings which form a part hereof. The drawings show, by way of illustration, specific examples in which the present molding systems and methods can be practiced. These examples are described in sufficient detail to enable those skilled in the art to practice, and it is to be understood that other embodiments can be utilized and that structural changes can be made without departing from the scope of the present disclosure. Terms indicating direction, such as front, rear, left, right, up, and down, are generally used only for the purpose of illustration or clarification and are not intended to be limiting. The following Detailed Description is not to be taken in a limiting sense, and the scope of the present disclosure is defined by the appended claims and their equivalents.

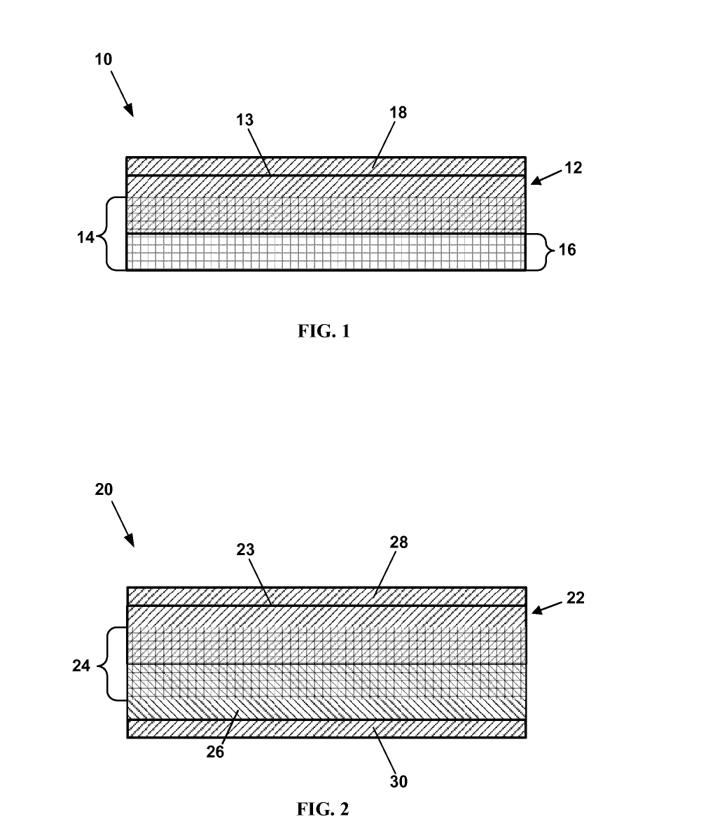

FIG. 1 shows a cross-sectional view of a composite film 10 comprising a polybutylene terephthalate (PBT) layer 12 bonded to a substrate layer 14. In an example, the substrate layer 14 comprises a fabric substrate, such as a non-woven fabric, for example a polyester-based nonwoven fabric. For simplicity, therefore, the substrate layer 14 will be referred to herein as a fabric substrate layer 14.

### PBT Layer

The PBT layer 12 can be laminated to the fabric substrate layer 14, for example by extruding PBT onto the fabric substrate layer 14 so that the PBT layer 12 can become bonded to the fabric substrate layer 14. In an example, the fabric substrate layer 14 can be at least partially embedded in the PBT layer 12, for example by becoming at least partially embedded in molten PBT after the PBT has been extruded but before the PBT solidifies to form the PBT layer 12. In an example, the PBT layer 12 is formed by extrusion casting, such as with a hanger-shaped die, onto the fabric substrate layer 14. Extrusion casting can comprise extruding a PBT resin that can be extrusion cast, such as a cast film grade PBT resin. In an example, a surface 13 of the PBT layer 12 can be mirror-finished or matte-finished. In an example, the PBT resin that can be extrusion cast to form the PBT layer 12 can have a melt flow rate from about 15 to about 30 at 250° C. Examples of PBT resins that can be extrusion cast to form the PBT layer 12 include, but are not limited to, CRASTIN 6130 polybutylene terephthalate resin sold by E.I. du Pont de Nemours and Company, of Wilmington, Del., USA, or ULTRADUR B4500, sold by BASF SE, of Ludwigshafen, Germany.

In an example, a release film 18 can optionally be included, for example to protect the surface 13 of the PBT layer 12 during further fabrication of the composite film 10. For example, if the surface 13 has a mirror or glossy finish, as described elsewhere in this disclosure, the release film 18 can be applied to the surface 13 of the PBT film 12 to protect the glossy finish of the surface 13. Examples of materials that can be used to form the release film 13 include, but are not limited to: a polyolefin, such as polypropylene, a polypropylene copolymer, polyethylene, or a polyethylene copolymer; and polyesters such as polyethylene terephthalate (PET), such as a biaxially-oriented PET with an adhearable coating on at least one side.

### Pigment

The PBT layer 12 can comprise, in addition to polybutylene terephthalate, one or more pigments. In an example, the pigment can comprise a white pigment, such as titanium dioxide (TiO₂). A white pigment can allow the PBT layer 12 to be white in color, which can provide for a neutral undertone with moderate opacity strength, which in turn can allow for relatively easy color formulation work in order to provide for printing or painting of essentially any desired color or graphics or both on the PBT layer 12. A TiO₂ white pigment can be preferred because it has good UV stability compared to other pigments, and because it can be made with small particle size and can be made to have better dispersion in plastic because it can be relatively easily coated with silicon or other coatings.

Examples of a white pigment that can be used in the formulation of the PBT layer 12 include, but is not limited to, TiO₂, such as TI-PURE R-105 titanium dioxide, sold by E.I. du Pont de Nemours and Company, of Wilmington, Del., USA. The pigment can be specially designed for outdoor plastics applications (as is the TI-PURE R-105 pigment). For example, the particles of TiO₂ in the pigment can be coated, e.g., with a silicone coating, which can have better UV stability compared to uncoated TiO₂ particles. Uncoated TiO₂ can result in the formation of free radicals when the TiO₂ is exposed to UV, which can accelerate degradation of the polymer matrix within the PBT layer 12. In an example, the loading of the pigment in the PBT layer 12 can be from about 2 wt. % to about 15 wt. %, wherein the loading of the pigment can depend on the specific pigment used and the thickness of the PBT layer 12. For example, a PBT layer 12 that has a thickness of about 20 mil (about 0.5 mm) can require a loading of about 3 wt. % of a particular TiO₂ pigment, a similarly formulated PBT layer 12 with a thickness of about 16 mil (about 0.4 mm) can require a loading of about 4 wt. % of the same TiO₂ pigment, and similar PBT layer 12 with a thickness of about 10 mil (about 0.25 mm) may require a loading of about 5 wt. % of the TiO₂ pigment, a similar PBT layer 12 with a thickness of about 6 mil (about 0.15 mm) can require a loading of about 9 wt. % of the TiO₂ pigment, and a similar PBT layer 12 with a thickness of 2 mil (about 0.05 mm) can require a loading of about 15 wt. % of the TiO₂ pigment.

Further details regarding TiO₂-based pigments that can be used in the PBT layer 12 are disclosed in U.S. Pat. No. 6,869,991, entitled “White UV-stabilized thermoformable film made from a crystallizable thermoplastic, method for producing the same and its use,” the disclosure of which is incorporated herein by reference as if reproduced herein in its entirety.

The one or more pigments can comprise, in addition to or in place of the white pigments described above, pigments of other colors, including, but not limited to, gray, red (e.g., dark red, light red, or shades of pink), orange, yellow, green (e.g., light green or dark green), blue (e.g., light blue or dark blue), indigo, purple, black, brown, or tan, or other colors comprising a mixture of two or more of these colors. For example, a gray color can be made with titanium dioxide and a very small percentage of carbon black. A red color can be made with pigment Cadmium Red (cadmium selenide). An orange color can be made with pigment Cadmium Orange (cadmium sulfoselenide). A yellow color can be made with pigment Cadmium Yellow (cadmium sulfide). A green color can be made with pigment Chrome Green (chromic oxide). A blue color can be made with pigment Cerulean Blue (cobalt (II) stannate). A purple color can be made with pigment Cobalt Violet (cobalt orthophosphate). A brown color can be made with pigment Raw Umber. A black color can be made with pigment Carbon Black. Other colors might be made with mixture of these example pigments. The loading of the pigment or mixture of pigments in the PBT layer 12 can be from about 0.5 wt. % to about 15 wt. %, wherein the loading of the pigment can depend on the specific pigment(s) used and the thickness of the PBT layer 12.

### UV Stabilizer

The PBT layer 12 can also comprise one or more UV stabilizers such that the composite film 10 can be a UV-stabilized film. As used herein, the term “UV stabilizer” can refer to an additive that can be added to the PBT layer 12 to allow the PBT of the PBT layer 12 to become UV stabilized. As used herein, the terms “UV stabilized” and “UV-stabilized film” can refer to a film having improved resistance to ultraviolet light (UV) exposure compared to a film that does not include the UV stabilizer. A UV-stabilized film can also demonstrate one or more of the following properties compared to films that do not include the UV stabilizer: improved retention of mechanical properties over time as the film is exposed to UV, reduced color shift as the film is exposed to UV, and reduced yellowing, particularly for white films such as the white PBT layer 12 described herein.

Examples of UV stabilizers that can be used to UV-stabilize the PBT layer 12 include, but are not limited to, TINUVIN UV stabilizers, such as TINUVIN 1600 or TINUVIN 1577, sold by BASF SE, of Ludwigshafen, Germany, CYASORB CYNERGY Solutions UV stabilizers, sold by Cytec Industries, Inc., of Woodland Park, N.J., USA, such as one or more of CYASORB A430, CYASORB UV-3638F, and CYASORB UV-3529 (such as using solely CYASORB A430, or using a mixture of CYASORB UV-3638F and CYASORB UV-3529). In an example, the loading of the UV stabilizer in the PBT layer 12 can be from about 0.5 wt. % to about 1.5 wt. %.

Further details regarding providing a UV-stabilized film is disclosed in U.S. Pat. No. 6,869,991, cited above. U.S. Pat. No. 6,869,991 primarily describes producing a UV-stabilized polyethylene terephthalate (PET) film. However, the inventor has discovered that many of the teachings of this patent are useful in producing a UV-stabilized PBT film as well.

### Antioxidant and Other Additives

The PBT layer 12 can comprise other additives, such as one or more antioxidants, or one or more other pigments or colorants beyond the white pigment described above to achieve a different color or opacity of the composite film 10. The addition of an antioxidant to the PBT layer 12 can provide for one or more of: the prevention or amelioration of oxidation of PBT, lower discoloration during compounding or extrusion, and enhancing UV stability of the composite film 10 when combined with UV stabilizers. In an example, loading of antioxidant in the PBT layer 12 can be from about 0.1 wt. % to about 0.3 wt. %. Examples of antioxidant that can be used in the PBT layer 12 include, but are not limited to, IRGANOX antioxidant (such as IRGANOX 245) or IRGAFOS antioxidant (such as IRGAFOS 126) sold by BASF SE, of Ludwigshafen, Germany, such as a mixture of IRGANOX 245 and IRGAFOS 126, or a CYANOX antioxidant sold by Cytec Industries, Inc., of Woodland Park, N.J., USA, such as CYANOX 2777.

In an example, the PBT layer 12 can comprise a polybutylene terephthalate (PBT) resin, such as CRASTIN 6130 polybutylene terephthalate resin sold by E.I. du Pont de Nemours and Company, of Wilmington, Del., USA, loaded with from about 2 wt. % to about 15 wt. % of a titanium dioxide (TiO₂) white pigment, such as TI-PURE R-105 titanium dioxide, sold by E.I. du Pont de Nemours and Company, of Wilmington, Del., USA, from about 0.5 wt. % to about 1.5 wt. % of a UV stabilizer, such as TINUVIN 1600 or TINUVIN 1577, sold by BASF SE, of Ludwigshafen, Germany, and from about 0.1 wt. % to about 0.3 wt. % of an antioxidant, such as IRGANOX 245 or IRGAFOS 126, sold by BASF SE, of Ludwigshafen, Germany. The pigment, the UV stabilizer, and the additives can provide for a desired color (e.g., white, gray, purple, blue, green, yellow, orange, red, brown, black, or mixtures thereof, as described above) and improved UV stability of the composite film 10.

### Fabric Substrate Layer

The substrate layer 14 can comprise a fabric layer, such as a non-woven fabric. In an example, the substrate layer 14 can comprise a thermally bonded non-woven fabric. The non-woven fabric of the fabric substrate layer 14 can have a weight of from 14 grams/square yard (g/yd²) (about 16 grams/square meter (g/m²)) to about 114 g/yd² (about 136 g/m²).

In an example, the non-woven fabric can be a polyester-based fabric, such as thermally bonded nonwoven fabrics comprising polyester fiber, such as a polyethylene terephthalate (PET)-based fiber. A PET-based fiber can provide advantages over other fibers in the composite film 10. For example, PET-based fibers can have high mechanical strength and relatively high melting points. PET-based fibers may also provide for stronger bonding at the interface of the PET-based fiber and the PBT melt that is cast onto the fabric substrate layer 14 to form the PBT layer 12 of the composite film 10, for example because the surface of the PET-based fiber may melt slightly during cast process and because PET and PBT are chemically very similar polyesters that are generally at least partially compatible.

In an example, the polyester-based fiber comprises a PET with a melting point of about 250° C. In another example, the polyester-based fiber can comprise a bi-component polyester fiber with PET as a core and a co-polyester as a sheath, e.g., a co-polyester having a reduced melting point compared to the PET core, e.g., a melting point of from about 100° C. to about 130° C., such as about 110° C. Further examples of polyester-based fiber that can be used in the fabric substrate layer 14 include a bi-component fiber with a PET core and a polyolefin sheath, such as a sheath comprising a polypropylene, a polypropylene-based copolymer, a polyethylene, or a polyethylene-based copolymer. The fiber that forms the fabric substrate layer 14 can also include blends of fiber and co-polyester binder powder. The fiber blend can comprise two or more of the following fibers: a polyester fiber, a bi-component polyester fiber (e.g., with a PET core and a co-polyester sheath), a bi-components polyester and polyolefin fiber (e.g., with a PET core and a polyolefin sheath), or a polypropylene fiber. In an example, the co-polyester binder that can be combined with the fiber (either a fiber blend or a non-blended fiber) can have a lower melting point than the fiber blends, e.g. from about 120° C. to about 140° C.

If a bi-component fabric or a binder powder is used, the lower melting point of the sheath polymer or the binder powder can provide for improved thermal bonding between the non-woven fabric of the fabric substrate layer 14 and the PBT layer 12 because the lower-melting point sheath polymer or binder powder can at least partially melt during extrusion of the PBT melt onto the fabric substrate layer 14 to form the PBT layer 12.

Further details of fibers that can be used in non-woven fabrics to form the fabric substrate layer 14 are described in U.S. Pat. No. 5,733,635, entitled “Laminated non-woven fabric and process for producing the same,” the disclosure of which is incorporated herein by reference as if reproduced herein in its entirety.

### Composite Film

As noted above, the fabric substrate layer 14 can be at least partially embedded in the PBT layer 12. In some examples, at least a portion 16 of the fabric substrate layer 14 can protrude from the PBT layer 12, as shown in FIG. 1. As described in more detail below, the protruding portion 16 can be used for bonding to a subsequent substrate directly, or bonding to sealant, or bonding to a lamination adhesive, so that the composite film 10 can be bonded to the subsequent substrate. The protruding portion 16 of the fabric substrate layer 14 can become embedded into a melt, e.g., a polymer melt that can form the subsequent substrate.

The thickness of the protruding portion 16 of the fabric substrate layer 14, e.g., the portion 16 that protrudes out of the PBT layer 12, can depend on the thickness of the fabric, e.g., the non-woven fabric, that makes up the fabric substrate layer 14, the thickness of the PBT melt that forms the PBT layer 12, and processing conditions such as nip roller pressure against the PBT melt and the fabric (with a larger nip roller pressure resulting in a larger percentage of the fabric being embedded in the PBT layer 12, which, in turn, means a smaller thickness for the protruding portion 16 of the fabric substrate layer 14). In an example, the thickness of the protruding portion 16 can be from about 1 mil (about 0.025 mm) to about 5 mil (about 0.13 mm). Preferably, the thickness of the protruding portion 16 is large enough to allow for bonding between the PBT layer 12 and any subsequent layer or substrate that may be bonded to the composite film 10, as described in more detail below. Preferably, the subsequent substrate that is formed and bonded to the composite film 10 remains fully intact after the subsequent substrate is applied, e.g., so that the fabric substrate layer 14 does not protrude out of the back side of the subsequent substrate. Therefore, preferably the thickness of the protruding portion 16 of the fabric substrate layer 14 is not so large that the fabric substrate layer 14 will protrude from the back of the subsequent substrate.

The PBT layer 12 including the UV stabilizer and the pigment, particularly the TiO₂ white pigment, can have sufficient UV stability to be used as an externally facing film (e.g., either facing outward so that it is exposed to natural light, e.g., sunlight, or facing inward into an interior so that it is exposed to artificial light, such as incandescent of fluorescent lighting) and can avoid discoloration or polymer degradation for a substantial period of time, e.g., at least 2 years of UV exposure, such as at least 3 years. The formulations of the PBT layer 12 described above can also provide for adequate mechanical integrity to withstand exposure to weather and other expected mechanical wear, for example if the composite film 10 is used as an externally-facing surface of a motor vehicle, such as a bus or recreational vehicle (RV), including resistance to scratching.

### Method of Making the Composite Film

The composite film 10 can be made via extrusion casting by extruding a PBT melt from a hanger die and casting the PBT melt on the fabric substrate layer 14 to form the PBT layer 12. In an example, the thickness of PBT film (melt) can range from about 2 mil (about 0.05 mm) to about 22 mil (about 0.55 mm). In an example, the fabric substrate layer 14 onto which the PBT melt can be extruded can have a thickness of from about 2 mil (about 0.05 mm) to about 20 mil (about 0.5 mm). In examples where the fabric substrate layer 14 is being used as a bonding layer for a subsequent substrate, described in more detail below, the thickness of the fabric substrate layer 14 may only need a thickness of 10 mil (about 0.25 mm) or less. In an example, the finished composite film 10 can have a thickness from about 3 mil (0.076 mm) to about 25 mil (0.64 mm).

As described above, the extrusion casting of the PBT melt onto the fabric substrate layer 14 can be such that at least a portion of the fabric substrate layer 14 becomes embedded in the PBT melt so that a portion 16 of the fabric substrate layer 14 protrudes from the PBT melt, and thus the PBT layer 12. The surface 13 of the PBT layer 12 can be mirror-finished, for example by being processed by a chill roller, such as a chrome chill roller. The surface 13 can also be matte finished. The embedded portion of the fabric substrate layer 14 can become bound to the PBT as the PBT melt sets to form the PBT layer 12, thus forming the laminated composite film 10.

If a surface of PBT film 13 is to be protected for further fabrication, the release film 18 can be included with the PBT film 13. In an example, the release film 18 is a strippable biaxial-oriented PET film with an adhearable coating on one side to generate adequate bonding with the PBT film surface. A PBT melt can be extruded from a hanger die and sandwiched between the fabric substrate layer 14 and the release film 18 at a nip to form the PBT layer 12. In an example, the fabric substrate layer 14 can be feed in from a nip roller side and the release film 18 can be fed in from a chill roller side.

In an example, a virgin PBT resin can be compounded with a pigment, such as TiO₂, to form a compounded PBT-pigment resin. Compounding of the virgin PBT resin with the pigment can provide for homogeneous or substantially homogenous color dispersion of the pigment in the PBT resin. One or more UV stabilizers can be compounded with the virgin PBT resin to make a UV-stabilized PBT master batch. In an example, the PBT layer 12 can be formed by extrusion casting a PBT melt by coextruding the compounded PBT-pigment resin with the UV-stabilized PBT master batch. In another example, the virgin PBT resin can be compounded with the pigment, e.g., TiO₂, and one or more UV stabilizers to form a UV-stabilized PBT-pigment master batch. Then, the virgin PBT resin, the UV-stabilized PBT-pigment master batch, and the UV-stabilized PBT master batch (described above), can be extruded together. An antioxidant can be compounded with the virgin PBT resin, with the compounded PBT-pigment resin, with the UV-stabilized PBT master batch, or with the UV-stabilized PBT-pigment master batch. Compounding of the pigment, e.g., TiO₂, the UV stabilizers, and the antioxidant into the PBT resin can be desirable because it can be difficult to handle these compounds (which are typically supplied as powders) and feed them to the extrusion without the powders flying into the air. It can also be difficult to add the additives in small loading amounts (such as 2 wt. % to 15 wt. % for the TiO₂ pigment, 0.5 wt. % to 1.5 wt. % for the UV stabilizer, and 0.1 wt. % to 0.3 wt. % of the antioxidant.

Due to the moisture sensitivity, one or more of the virgin PBT resin, the compounded PBT-pigment resin, the UV-stabilized PBT master batch, or the UV-stabilized PBT-pigment resin or master batch, will require drying prior to extrusion.

During extrusion casting of the PBT melt, it can be desirable to limit or minimize orientation of the PBT film that forms the PBT layer 12. Limited or minimized orientation of the PBT layer 12 can avoid or limit deformation or shrinking of the PBT layer 12 during subsequent extrusion or lamination, for example when forming a composite panel (described below).

### Sealant or Adhesive Layer

FIG. 2 shows an example of another composite film 20. Like the composite film 10 described above, the composite film 20 can include a PBT layer 22 bonded to a substrate layer 24, which can be a fabric substrate, such as a non-woven fabric, which can be referred to as a fabric substrate layer 24. The composite film 20 can also optionally include a release film 28, for example on a surface 23 of the PBT layer 22. The PBT layer 22, the fabric substrate layer 24, and the release film 28 can be similar or identical to the aspects recited above with respect to the PBT layer 12, the fabric substrate layer 14, and the release film 18, including materials, additives, and compositions (e.g., loading, etc.).

The composite film 20 can also include one or more additional layers 26, which can comprise a sealant layer, an adhesive layer, or both. In an example, shown in FIG. 2, the additional layer 26 can penetrate all the way through the fabric substrate layer 24, so that the material of the additional layer 26 is in contact with the PBT layer 22, e.g., so that there is no free, non-embedded portion of the fabric substrate layer 24.

In an example where the additional layer 26 comprises an adhesive layer, the adhesive layer can be to allow for adhesion of the composite film 20 to another substrate or surface where the other substrate or surface cannot be bonded onto the composite film 20 via extrusion, as described below regarding the formation of a composite panel. In an example, an adhesion layer (used as one of the additional layers 26) can comprise a pressure sensitive adhesive, which can comprise at least one of a polyacrylate-based adhesive, a polyurethane-based adhesive, a polyolefin/elastomer-based adhesive, or a poly(ethylene-co-acrylate acid)-based adhesive. The adhesive of the adhesive layer can be a peelable adhesive, e.g., like adhesive tapes made and sold by 3M Company, of St. Paul, Minn., USA, or an unpeelable adhesive.

In an example where the additional layer 26 comprises a sealant layer, the sealant layer can comprise a material for heat sealing of the film 20. Examples of sealant materials that can be used to form a sealant layer include, but are not limited to, a polyolefin elastomer or plastomer, such as a polyethylene, a polyethylene-based copolymer, a polypropylene, or a polypropylene-based copolymer with a low melting point, e.g., from about 50° C. to about 120° C. Typically, a sealant layer does not require a release liner. The sealant layer can be further sealed with other polyolefin-based boards or sheets to make a board or sheet. During heat sealing, damage to the PBT layer 22 can be limited or eliminated in most case due to the high melting point of the PBT, e.g., from about 220° C. to about 230° C. The heat seal can be for the entire composite film 20 or part of the composite film 20, depending on the applications. An example of an application where a partial heat seal may be useful is a bag for food storage, such as a cereal bag or a snack chip bag, where there is a sealant layer inside of the bag and a heat seal on the inside sealant layer at the top and bottom of the bag.

The composite film 20 can also include a second release film 30 configured to protect the additional layer 26, for example if the adhesive or the sealant of the additional layer 26 requires a release liner. The release film 30 can be similar, e.g., similar or different materials or sizes, as the release films 18, 28 described above. The release film 30 can be poly(ethylene terephthalate) (PET), polyethylene, or polypropylene depends on the materials of adhesive or sealant layer 26. In other examples, the adhesive or sealant of the additional layer 26 can be an adhesive or sealant that does not require a release liner. Therefore, the composite film 20 can comprise neither release film 28 or release film 30, or can comprise only the release film 28 for the PBT layer 22, or can comprise only the release film 30 for the additional layer 26, or can comprise both the release film 28 for the PBT layer 22 and the release film 30 for the additional layer 26.

The one or more additional layers 26 can be applied to the fabric substrate layer 24 by any method that will provide for adequate bonding of the additional layer 26 to the fabric substrate layer 24, including, but not limited to, direct application (in the case of an adhesive layer, such as a pressure-sensitive adhesive), extrusion (including extrusion casting, extrusion lamination, and extrusion coating), lamination, and the like.

### Composite Panel

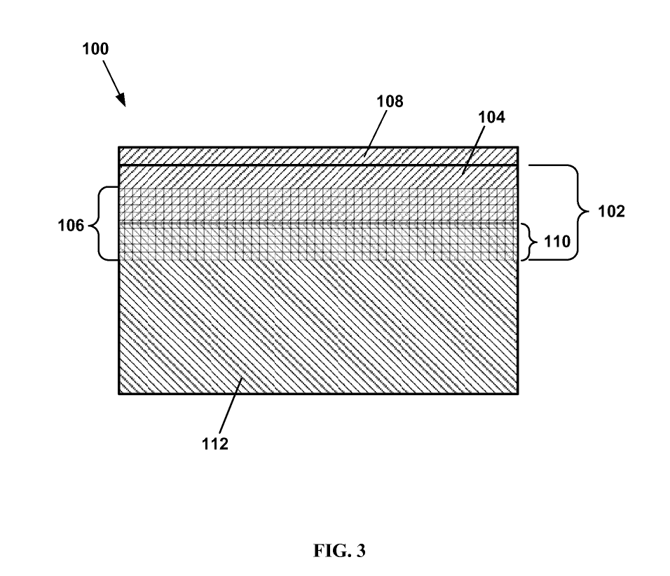

FIG. 3 shows an example of a composite panel 100 that can be formed by further processing the example composite films 10, 20 described above. The composite panel 100 can comprise a composite film 102, which can be substantially the same as either the composite film 10 described above with respect to FIG. 1 of the composite film 20 described above with respect to FIG. 2. The example composite film 102 shown in FIG. 3 can be similar to the composite film 10 of FIG. 1, e.g., with a PBT layer 104, a fabric substrate layer 106, and optionally a release film 108, wherein at least a portion of the fabric substrate layer 106 is embedded in the PBT layer 104 and another portion 110 of the fabric substrate layer 106 can protrude from the PBT layer 104. The PBT layer 104 can be identical or similar to the PBT layer 12 described above, the fabric substrate layer 106 can be identical or similar to the fabric substrate layer 14 described above, and the release film 108 can be identical or similar to the release film 18 described above. In an example, the composite film 10 described above is used as the composite film 102 in order to form the composite panel 100.

The composite panel 100 can also include a support substrate 112 that can be bonded to the fabric substrate layer 106, e.g., by being bonded to the protruding portion 110 of the fabric substrate layer 106. The support substrate 112 can be a relatively stiff substrate that provides for a rigid or substantially rigid support for the composite film 102, e.g., so that the composite panel 100 can be used as a structural member, for example in a vehicle. In an example, the support substrate 112 can be bonded to the fabric substrate layer 106 by extrusion lamination of the support substrate 112 onto the protruding portion 110 of the fabric support substrate 106. In an example, shown in FIG. 3, the support substrate 112 can be applied to the fabric substrate layer 106 so that the support substrate 112 penetrates all the way through the fabric substrate layer 106 so that the material of the support substrate 112 is in contact with the PBT layer 104, e.g., so that there is no free, non-embedded portion of the fabric substrate layer 106.

The support substrate 112 can be made from any material that can be bonded to the fabric support layer 106 of the composite film 102 and that can provide for desired structural and mechanical properties of the final composite panel 100. Examples of materials that can be used for the support substrate 112 include, but are not limited to, polypropylene, a polypropylene copolymer, polyethylene (such as high-density polyethylene (HDPE)), a polyethylene copolymer, or other plastomers and elastomers.

In an example, the composite film 102 is formed via the same method described above for forming the composite film 10, and then the support substrate 110 is applied to the protruding portion 110 of the fabric substrate layer 106 of the composite film 102, such as by extrusion lamination or extrusion coating of the support substrate 112, e.g., so that the protruding portion 110 fully penetrates into the support substrate 112.

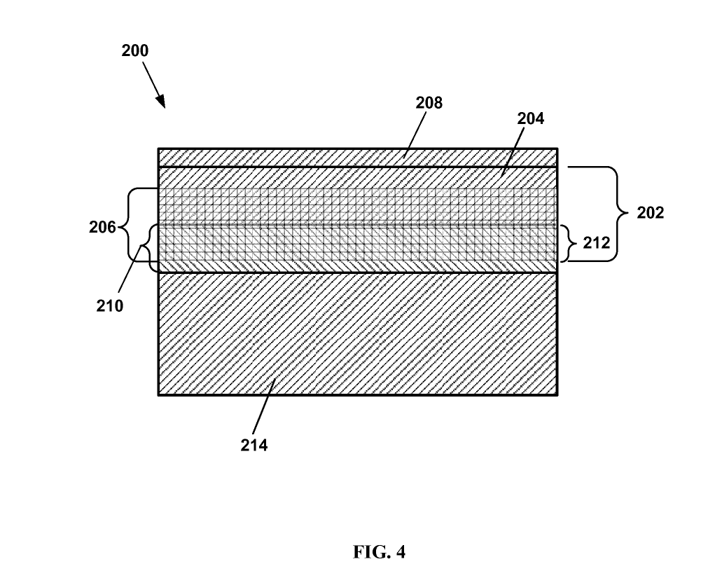

In another example, shown in FIG. 4, an example composite panel 200 can be made from a composite film 202. The composite film 202 can be similar to the composite film 102 described above, e.g., with a PBT layer 204, a fabric substrate layer 206, and optionally a release film 208. The composite panel 200 can include a lamination adhesion layer 210 that can be bonded to preformed substrate or board 212. The lamination adhesion layer 210 can also be bonded to the fabric substrate layer 206. In an example, the lamination adhesion layer can be bonded to a protruding portion 212 of the fabric substrate layer 206. A preformed substrate or board 214 can be coupled to the composite film 202 with the lamination adhesion layer 210. The preformed substrate or board 214 can be a relatively stiff substrate that provides for a rigid or substantially rigid support for the composite film 202. In an example, the composite panel 200 can be used as a structural member, for example in a vehicle. Examples of materials that can be used to form the preformed substrate or board 214 can included, but are not limited to, polyethylene (such as liner low density polyethylene, medium density polyethylene, or high density polyethelyene), polypropylene, or polyolefines, or other plastics or polymers.

### EXAMPLE

A PBT film was produced that included from about 0.5 wt. % to 1 wt. % TINUVIN 1600 UV stabilizer, sold by BASF SE, of Ludwigshafen, Germany, about 5 wt. % TI-PURE R-105 white titanium dioxide (TiO₂) pigment, sold by E.I. du Pont de Nemours and Company, of Wilmington, Del., USA, and 0.1 wt. % to 0.3 wt. % of a mixture of IRGANOX 245 and IRGAFOS 126 antioxidants, sold by BASF SE, of Ludwigshafen, Germany. The PBT film had a thickness of 10 mil (about 0.254 mm).

The PBT film was tested for UV stability in a Xenon Arc weather meter with ASTM 155 (cycle 1). After exposure under these conditions for 2000 hours, the PBT film shows approximately 85% tensile strength retention.

### COMPARATIVE EXAMPLE

A 10 mil (about 0.254 mm) thick control PBT film was formed without the UV stabilizers. The control PBT film was also tested for UV stability in the Xenon Arc weather meter with ASTM 155 (cycle 1). After exposure under these conditions for 2000 hours, the control PBT film shows approximately 45% tensile strength retention, or about 50% of the tensile strength retention of that of the PBT film that includes UV stabilizers.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented, at least in part. Some examples can include a computer-readable medium or machine-readable medium encoded with instructions operable to configure an electronic device to perform methods or method steps as described in the above examples. An implementation of such methods or method steps can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Although the invention has been described with reference to exemplary embodiments, workers skilled in the art will recognize that changes may be made in form and detail without departing from the spirit and scope of the invention.

What is claimed is:

1. A composite film comprising:
a polymer layer comprising polybutylene terephthalate loaded with from about 0.5 wt. % to about 15 wt. % of one or more pigments, and from about 0.5 wt. % to about 1.5 wt. % of one or more UV stabilizers; and
a fabric substrate layer at least partially embedded in and bonded to the polymer layer.

2. The composite film of claim 1, wherein the polybutylene terephthalate has a melt flow rate from about 15 to about 30 at 250° C.

3. The composite film of claim 1, wherein the polymer layer comprises from about 0.1 wt. % to about 0.3 wt. % of one or more antioxidants.

4. The composite film of claim 1, wherein the one or more pigments comprise a white pigment.

5. The composite film of claim 4, wherein the white pigment comprises a titanium dioxide pigment.

6. The composite film of claim 5, wherein the titanium dioxide pigment has a loading of about 2 wt. % to about 15 wt. %.

7. The composite film of claim 5, wherein the titanium dioxide pigment comprises titanium dioxide particles with a silicone coating.

8. The composite film of claim 1, wherein the one or more pigments comprise a non-white pigment including one or more of: a gray pigment; a red pigment; an orange pigment; a yellow pigment; a green pigment; a blue pigment; a purple pigment; a violet pigment; a brown pigment; and a black pigment.

9. The composite film of claim 1, wherein the one or more pigments comprise a non-white pigment including one or more of:
a gray pigment;
a red pigment comprising cadmium selenide;
an orange pigment comprising cadmium sulfoselenide;
a yellow pigment comprising cadmium sulfide;
a green pigment comprising chromium (III) oxide;
a blue pigment comprising cobalt (II) stannate;
a purple pigment comprising cobalt orthophosphate;
a brown pigment comprising umber; and
a black pigment comprising carbon black.

10. The composite film of claim 1, wherein the fabric substrate layer comprises one or more non-woven fibers.

11. The composite film of claim 1, wherein the fabric substrate layer comprises one or more polyethylene terephthalate-based fibers.

12. The composite film of claim 11, wherein the polyethylene terephthalate-based fiber comprises at least one of: a polyethylene terephthalate fiber; a bi-component polyester fiber with a polyethylene terephthalate core and a co-polyester sheath; a bi-component fiber with a polyethylene terephthalate core and a polyolefin sheath; or a fiber blend comprising two or more of a polyethylene terephthalate fiber, a bi-component fiber with a polyethylene terephthalate core and a co-polyester sheath, a bi-component fiber with a polyethylene terephthalate core and a polyolefin sheath, or a polypropylene fiber.

13. The composite film of claim 12, wherein the polyolefin sheath comprises at least one of a polyethylene, a polypropylene, a polyethylene copolymer, or a polypropylene copolymer.

14. The composite film of claim 1, further comprising a first release film applied to a surface of the polymer layer.

15. The composite film of claim 14, wherein the surface of the polymer layer to which the first release film is applied has a glossy or mirrored finish.

16. The composite film of claim 1, wherein at least a portion of the fabric substrate layer protrudes from the polymer layer.

17. The composite film of claim 16, further comprising an additional layer bonded to at least the protruding portion of the fabric substrate layer, the additional layer comprising at least one of a rigid or substantially rigid support substrate; an adhesive; a sealant; and a lamination adhesion layer.

18. The composite film of claim 17, further comprising a second release film applied to the additional layer.

19. The composite film of claim 17, wherein the additional layer comprises the rigid or substantially rigid support substrate, the support substrate comprises at least one of a polypropylene, a polypropylene copolymer, a polyethylene, and a polyethylene copolymer.

20. The composite film of claim 16, wherein the protruding portion of the fabric substrate layer has a thickness of from about 0.025 mm to about 0.13 mm.
